(19) United States
(12) Patent Application Publication
(10) Pub. No.: US 2009/0248965 A1
(43) Pub. Date: Oct. 1, 2009

(54) HYBRID FLASH MEMORY DEVICE AND METHOD OF CONTROLLING THE SAME

(75) Inventors: Yuan-Huei Lee, Taipei (TW); Chi Chang, Taipei (TW); Chia-Hsin Chen, Taipei (TW); Ming-Che Liu, Taipei (TW)

Correspondence Address: KIRTON AND MCCONKIE, 60 EAST SOUTH TEMPLE,, SUITE 1800, SALT LAKE CITY, UT, 84111, US

(73) Assignee: ASMEDIA TECHNOLOGY INC., Taipei (TW)

(21) Appl. No.: 12/401,466

(22) Filed: Mar. 10, 2009

(30) Foreign Application Priority Data
Mar. 25, 2008 (TW) 097110499

(51) Int. Cl. G06F 12/02; G06F 12/00

(52) U.S. Cl. 711/103; 711/E12.001; 711/E12.008

(57) ABSTRACT

A hybrid flash memory device and a control method of the hybrid flash memory device are provided. The hybrid flash memory device includes a micro controller connected to a host bus for receiving data to be written in the hybrid flash memory device from a host via the host bus; and a memory module coupled to the micro controller. The flash module includes a first type of flash memory and a second type of flash memory. The data are determined to be written in a first log block of the first type of flash memory when the data size is not greater than a predetermined data size. On the contrary, the data are determined to be written in a second log block of the second type of flash memory when the data size is greater than the predetermined data size.

### FIELD OF THE INVENTION

The present invention relates to a flash memory device and a method of controlling the memory device, and more particularly to a hybrid flash memory device and a control method thereof.

### BACKGROUND OF THE INVENTION

Since flash memory has the advantages of tolerance to shocks, non-volatility and high storage density, flash memory devices, combining flash memories and control circuits, are utilized worldwide. Known flash memory devices, for example, include thumb drives, compact flash cards (CF cards), secure digital cards (SD cards) and multimedia cards (MMC).

Generally, NAND flash memory on the market is classified into signal level cell (SLC) NAND flash memory and multi level cell (MLC) NAND flash memory. SLC flash memory stores one bit in each memory cell while MLC flash memory can store more than one bit in each memory cell.

SLC flash memory and MLC flash memory are produced from different processes. Although both of they belong to non-volatile memory, they have distinguishing features and efficiencies. The respective characteristics are described below.

SLC flash memory involves the following characteristic:
(1) supporting multi-write operation from arbitrary page;
(2) requiring simpler error correction codes due to higher reliability and maintainability of SLC flash memory;
(3) better durability and availability;
(4) requiring shorter block erase time and page programming time; and
(5) higher manufacturing cost.

MLC flash memory involves the following characteristic:
(1) once write operation and sequential-write from the lowest page;
(2) requiring complex error correction codes for correcting errors due to higher error rate in write operation of MLC flash memory;
(3) lower durability and availability;
(4) requiring longer block erase time and page programming time;
(5) lower cost; and
(6) higher storage density.

Please refer to FIG. 1A illustrating the typical structure of a flash memory device. The flash memory device 10 includes a micro controller 20 and a memory module 40. A host (not shown) can access data stored in the flash memory device 10 via a host bus 22, for example, compact flash (CF) bus, secure digital (SD) bus, multimedia card (MMC) bus, universal serial bus (USB), or IEEE1394.

The micro controller 20 uses a write instruction to control the memory module 40 and write data into the memory module 40 during a write operation. On the other hand, the micro controller 20 uses a read instruction to control the memory module 40 and read data to be outputted via the host bust 22 from the memory module 40 during a read operation.

FIGS. 1B and 1C illustrate the conventional components of the memory module 40 of the flash memory device 10. The memory module 40 consists of a plurality of single type flash memories such as SLC flash memories SLC 42-1˜42-N (FIG. 1B) or MLC flash memories MLC 44-1˜44-N (FIG. 1C). The memory module 40, for example SLC flash memory module or MLC flash memory module, is divided into a plurality of blocks, each of which includes a plurality of pages. Therefore, a memory mapping table is provided in the micro controller 20 for the mapping purpose. The memory mapping table contains pointers for mapping logical block address (LBA) to physical block address (PBA). Generally speaking, the read/write command issued by the host is based on logical block address. The micro controller 20 then find the corresponding physical block address according to the memory mapping table so as to read/write data at specific physical block address in the memory module 40.

Please refer to FIG. 2 illustrating the mapping between the memory mapping table and the memory module. For example, when the host issues a read command for data at LBA 0, the micro controller 20 indicates that the data are stored at PBA 5 in the memory module 40 according to the memory mapping table 35 so that the data stored at PBA 5 is read out and outputted to the host.

The write operation of flash memory device 100 consisting of SLC flash memories 42-1˜42-N has different mechanism from that consisting MLC flash memory 44-1˜44-N. The following examples of write operation are given providing that there are four pages in each block, i.e. Page 0, Page 1, Page 2 and Page 3. The micro controller 20 selects at least one free block from the blocks in the memory module 40 as log block(s) for written data.

Please refer to FIGS. 3A˜3G illustrating the write operation of a SLC flash memory device. The write operation for example includes (1) the host issuing a write command to write two pages of data D1′ and D2′ replacing old data D1 and D2 at LBA 0 from Page 1; (2) the host issuing a write command to write one page of data D0′ replacing old data D0 at LBA 0 from Page 0; and (3) the host issuing a write command to write four pages of data D7′, D8′, D9′ and D10′ replacing old data D7, D8, D9 and D10 at LBA 3 from Page 3. The word “replacing” means that the new data instead of the old data will be read out during the read operation. It is not necessary to write the new data at the same physical block address as the old data.

As shown in FIG. 3A, it is noted that the memory mapping table 35 in the micro controller 20 indicates that LBA 0, LBA 3 and LBA 4 point to PBA 1, PBA 7 and PBA 4 in the memory module 40, respectively. Data D0, D1, D2 and D3 occupy Page 0, Page 1, Page 2 and Page 3 of PBA 1; data D4, D5, D6 and D7 occupy Page 0, Page 1, Page 2 and Page 3 of PBA 7; and data D8, D9, D10 and D11 occupy Page 0, Page 1, Page 2 and Page 3 of PBA 4. Furthermore, there are two log blocks pre-set in the memory module 40 wherein PBA 5 is allocated to the first log block and PBA 3 is allocated to the second log block. The remained memory blocks PBA 0, PBA 2 and PBA 6 are free blocks.

To start the first write step, the host issues a write command to write two pages of data D1′ and D2′ replacing old data D1 and D2 at LBA 0 from Page 1. As shown in FIG. 3B, the new data D1′ and D2′ are directly placed in Page 1 and Page 2 of the first log block PBA 5 since SLC flash memory supports writing from arbitrary page.

To start the second write step, the host issues a write command to write one page of data D0′ replacing old data D0 at LBA 0 from Page 0. As shown in FIG. 3C, the new data D0′ are directly placed in Page 0 of the first log block PBA 5.

Then, the flash memory device receives the third write command of writing four pages of data D7′, D8′, D9′ and D10′ replacing old data D7, D8, D9 and D10 at LBA 3 from Page 3. That is, the new data D7′ should be written in Page 3 of LBA 3, and the new data D8′, D9′ and D10′ should be respectively written in Page 0, Page 1 and Page 2 of LBA 4. The new data D7′ are placed in Page 3 of the second log block PBA 3 as shown in FIG. 3D. At this step, no log block is available in memory module 40. A procedure of flushing out log block is required in order to designate a free block in the memory module 40 as a new first log block.

FIG. 3E illustrates a merging procedure 46 executed by the micro controller 20. The data D3 are copied from Page 3 of PBA 1 to Page 3 of PBA 5 and merged with data stored at PBA 5. Now Page 0, Page 1, Page 2 and Page 3 of PBA 5 are occupied with data D0′, D1′, D2′ and D3.

Then, the memory mapping table 35 is updated to have LBA 0 point to PBA 5 as shown in FIG. 3F. Hence, PBA 5 is occupied and not allocated to the first log block. The micro controller 20 has to select a new first log block, e.g. PBA 0, among the free blocks. A block erase command is issued to erase the useless data in PBA 1, and PBA 1 becomes available, i.e. a free block. Thus, the flushing out step is finished.

As shown in FIG. 3G, new data D8′, D9′ and D10′ are respectively placed in Page 0, Page 1 and Page 2 of the new first log block PBA 0 to complete the third write command.

Please refer to FIGS. 4A˜4G illustrating the write operation of a MLC flash memory device. The write operation includes the same write commands as exemplified above: (1) the host issuing a write command to write two pages of data D1′ and D2′ replacing old data D1 and D2 at LBA 0 from Page 1; (2) the host issuing a write command to write one page of data D0′ replacing old data D0 at LBA 0 from Page 0; and (3) the host issuing a write command to write four pages of data D7′, D8′, D9′ and D10′ replacing old data D7, D8, D9 and D10 at LBA 3 from Page 3.

As shown in FIG. 4A, it is noted that the memory mapping table 35 in the micro controller 20 indicates that LBA 0, LBA 3 and LBA 4 point to PBA 1, PBA 7 and PBA 4 in the memory module 40, respectively. Data D0, D1, D2 and D3 occupy Page 0, Page 1, Page 2 and Page 3 of PBA 1; data D4, D5, D6 and D7 occupy Page 0, Page 1, Page 2 and Page 3 of PBA 7; and data D8, D9, D10 and D11 occupy Page 0, Page 1, Page 2 and Page 3 of PBA 4. Furthermore, there are two log blocks pre-set in the memory module 40 wherein PBA 5 is allocated to the first log block and PBA 3 is allocated to the second log block. The remained memory blocks PBA 0, PBA 2 and PBA 6 are free blocks.

To start the first write step, the host issues a write command to write two pages of data D1′ and D2′ replacing old data D1 and D2 at LBA 0 from Page 1. As shown in FIG. 4B, the new data D1′ and D2′ are placed in Page 0 and Page 1 of the first log block PBA 5 since MLC flash memory has to be written from the lowest page.

To start the second write step, the host issues a write command to write one page of data D0′ replacing old data D0 at LBA 0 from Page 0. As shown in FIG. 4C, the new data D0′ are placed in the lowest available page, i.e. Page 2 of the first log block PBA 5.

Then, the flash memory device receives the third write command of writing four pages of data D7′, D8′, D9′ and D10′ replacing old data D7, D8, D9 and D10 at LBA 3 from Page 3. That is, the new data D7′ should be written in Page 3 of LBA 3, and the new data D8′, D9′ and D10′ should be written in Page 0, Page 1 and Page 2 of LBA 4 respectively. The new data D7′ are placed in Page 0 of the second log block as shown in FIG. 4D. At this step, no log block is available in memory module 40. A procedure of flushing out log block is required in order to designate a free block in the memory module 40 as a new first log block.

It is observed that the page sequence of the data D0′, D1′ and D2′ is incorrect. Therefore, the micro controller 20 performs a merging and sorting procedure 47 and a write to free block procedure 48 before executing the next write command. Please refer to FIG. 4E. In the merging and storing procedure 47, data D3 in PBA 1 and data D1′, D2′ and D0′ in the first log block are arranged and merged in the correct page sequence, i.e. in sequence of D0′, D1′, D2′ and D3. The write to free block procedure 48 follows to write the merged data into a free block, for example PBA 6.

Then, the memory mapping table 35 is updated to have LBA 0 point to PBA 6 as shown in FIG. 4F. Now, the micro controller 20 can select a new first log block, e.g. PBA 0, among the free blocks. Two block erase commands are issued to erase the useless data in PBA 1 and PBA 5 to change the status of PBA 1 and PBA 5 into free blocks. Thus, the flushing out step is finished.

As shown in FIG. 4G, new data D8′, D9′ and D10′ are respectively placed in Page 0, Page 1 and Page 2 of the new first log block PBA 0 to complete the third write command.

From the above description, it is known that the micro controller 20 has to perform a merging and storing procedure 47 and a write to free block procedure 48 because MLC flash memories have to be written from the lowest page. On the contrary, SLC flash memory requires only a merging procedure 46 because data can be written from arbitrary page. Although SLC flash memory has advantage of shorter page programming time, the high manufacturing cost is disadvantageous. A flash memory device provided with advantage of both SLC flash memory and MLC flash memory is desired.

### SUMMARY OF THE INVENTION

Therefore, the present invention provides a hybrid flash memory device adopting different types of flash memories.

The present invention also provides a method of controlling the hybrid flash memory device adopting different types of flash memories.

According to an aspect of the present invention, a hybrid flash memory device includes a micro controller connected to a host bus and a memory module coupled to the micro controller. The memory module includes a first type of flash memory and a second type of flash memory. The micro controller receives data to be written from a host via the host bus. The data are written in a first log block of the first type flash memory when the data size is not greater than a predetermined data size. On the contrary, the data are written in a second log block of the second type flash memory when the data size is greater than the predetermined data size.

According to another aspect of the present invention, a method of controlling a hybrid flash memory device is provided. The hybrid flash memory device includes a memory module having a first type of flash memory and a second type of flash memory. The method includes step of: receiving data to be written from a host; writing the data in a first log block of the first type of flash memory when the data size is not greater than a predetermined data size; and writing the data in a second log block of the second type of flash memory when the data size is greater than the predetermined data size.

### BRIEF DESCRIPTION OF THE DRAWINGS

The present invention will become more readily apparent to those ordinarily skilled in the art after reviewing the following detailed description and accompanying drawings, in which:

FIG. 1A is a block diagram illustrating the typical structure of a flash memory device;

FIGS. 1B and 1C are block diagrams illustrating two memory modules consisting of SLC flash memories and MLC flash memories respectively;

FIG. 2 is a block diagram illustrating the mapping between a memory mapping table and a memory module;

FIGS. 3A˜3G illustrates the write operation of a SLC flash memory device;

FIGS. 4A˜4G illustrates the write operation of a MLC flash memory device;

FIG. 5 is a block diagram illustrating an embodiment of a hybrid flash memory device according to the present invention; and

FIGS. 6A˜6I illustrates the write operation of the hybrid flash memory device of FIG. 5.

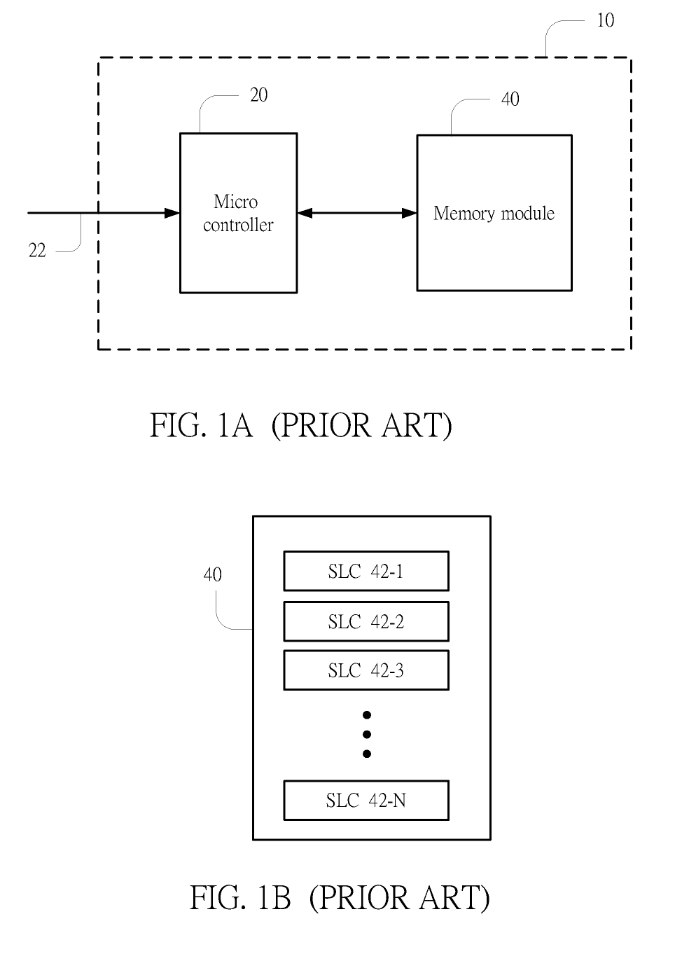

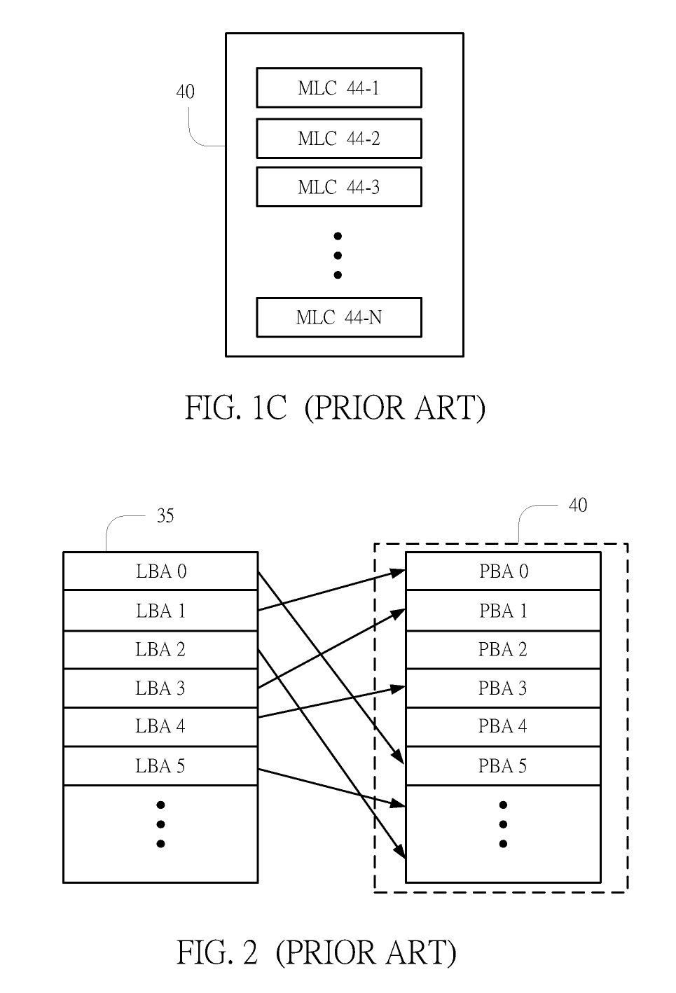

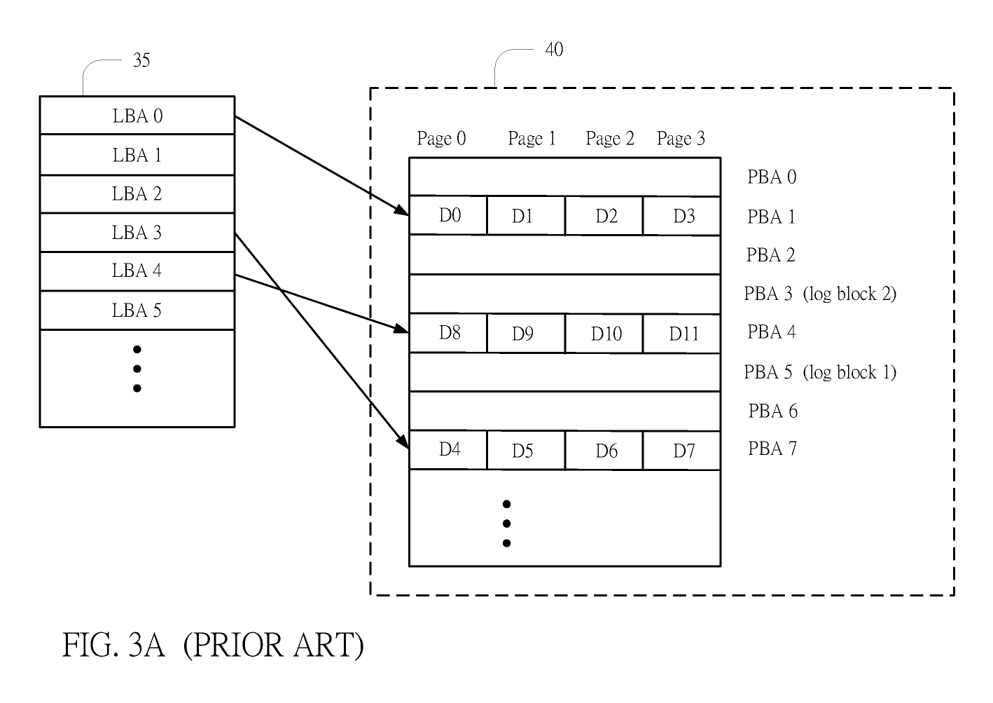

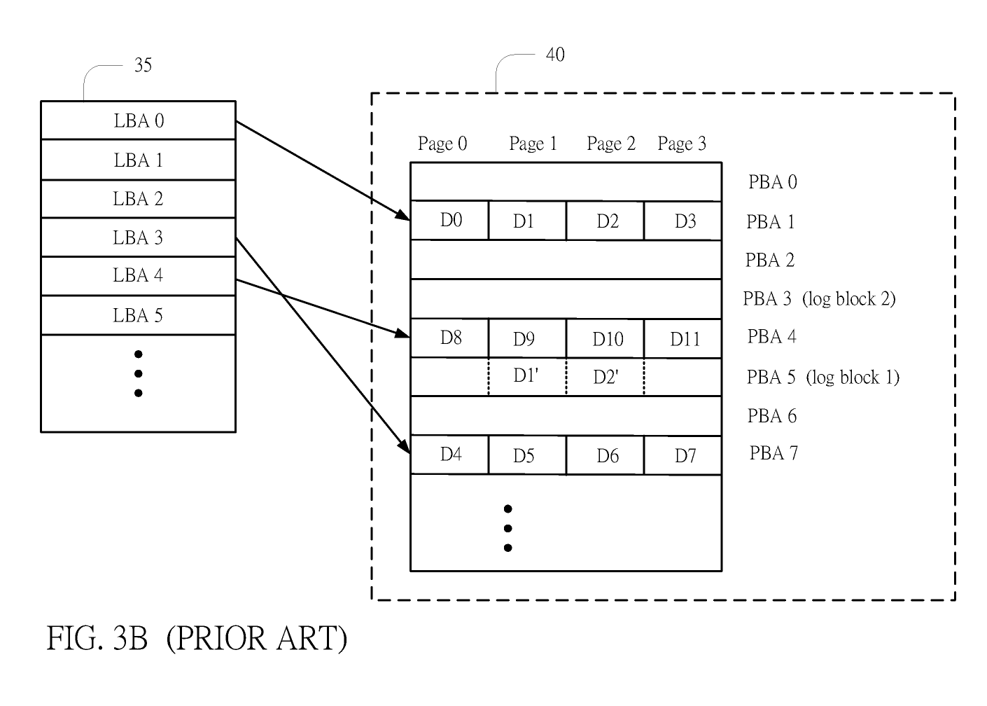

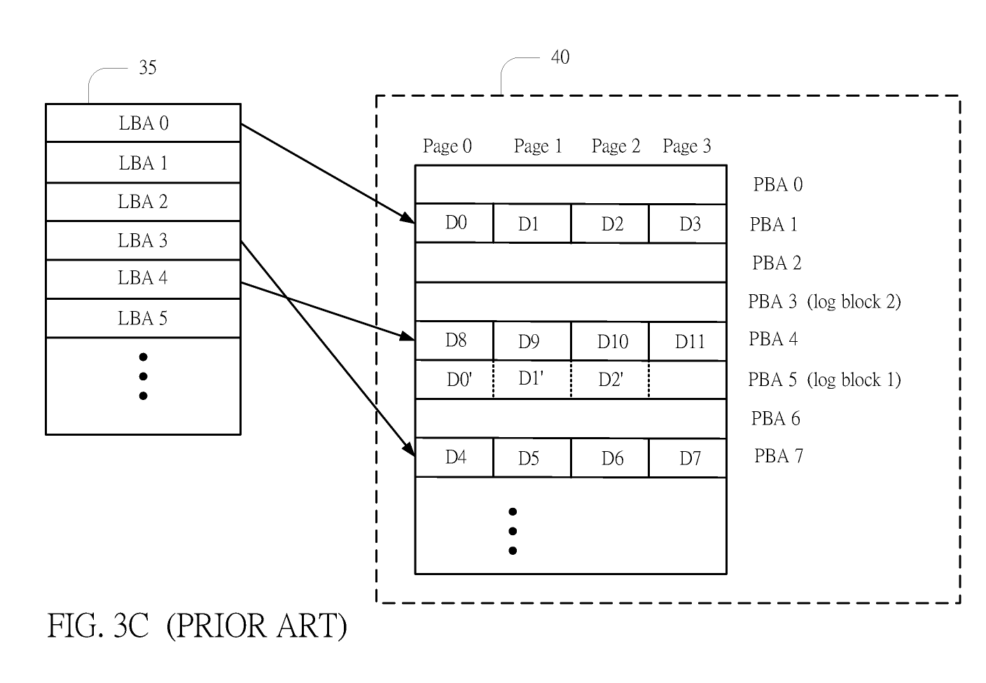

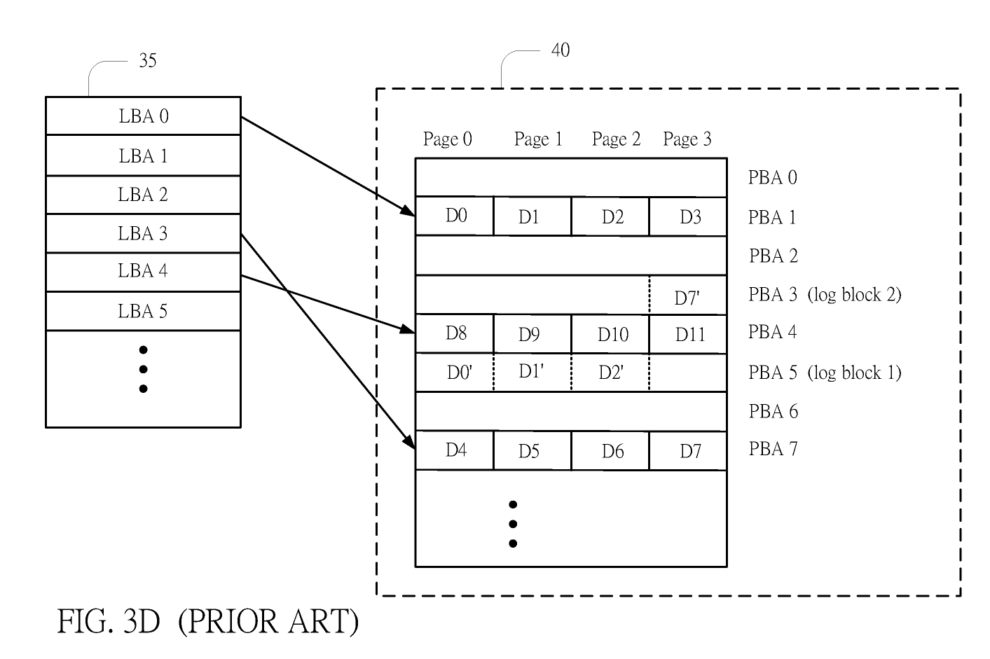

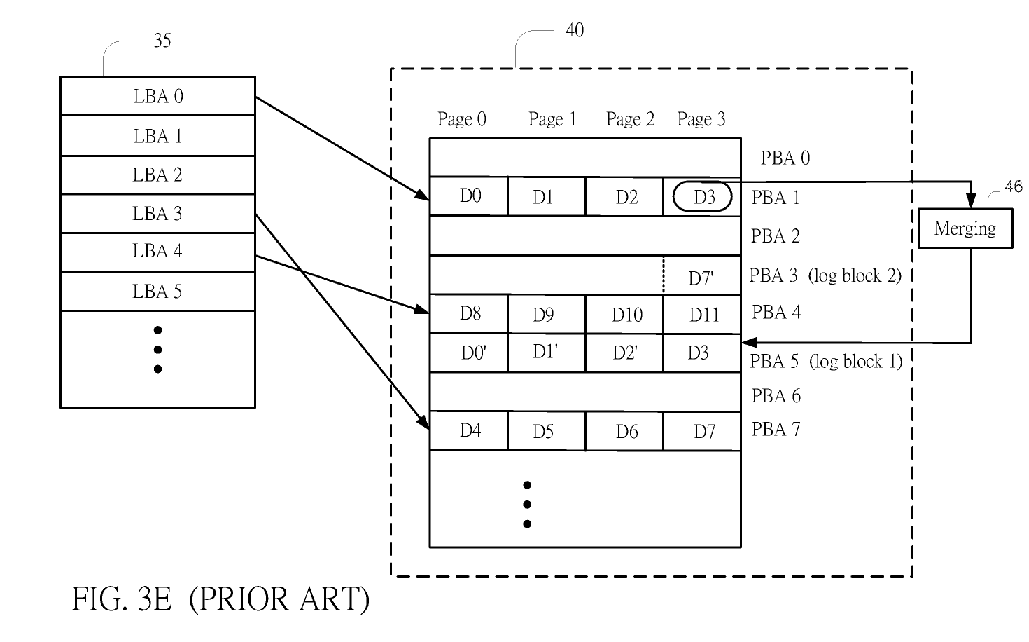

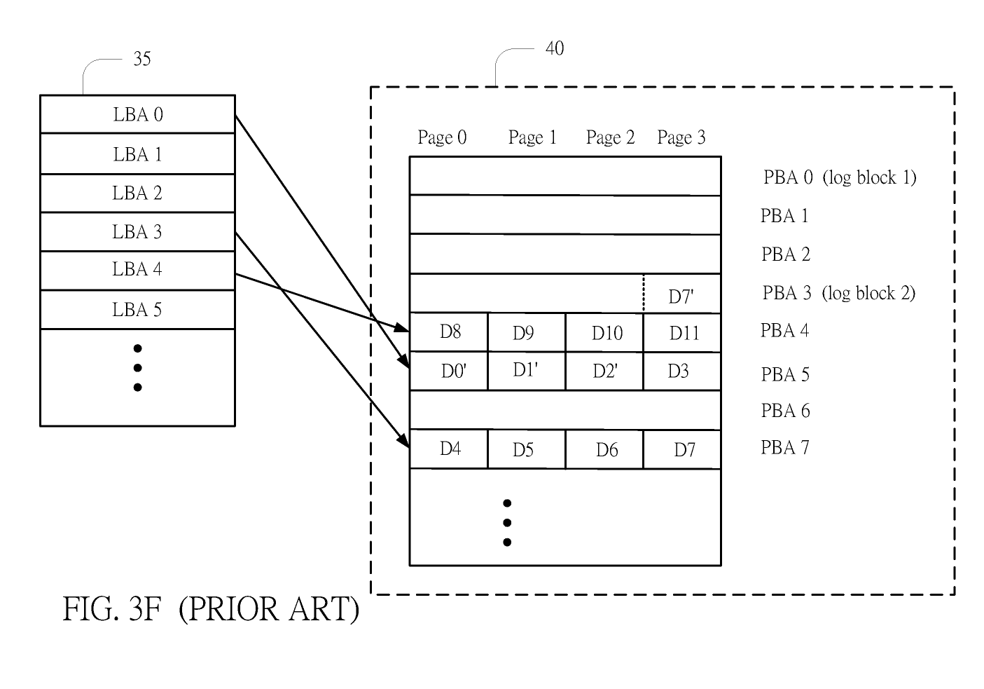

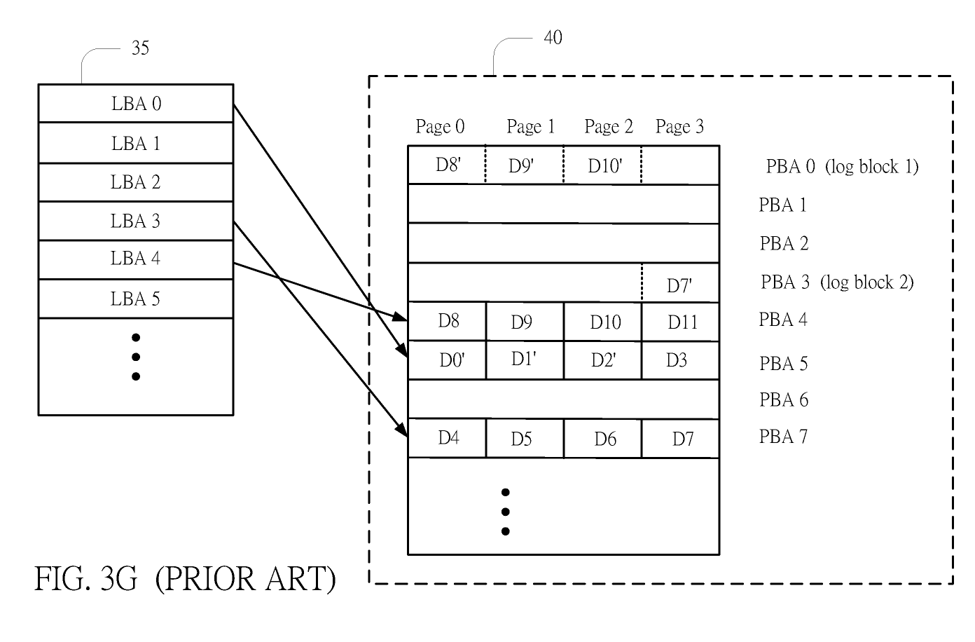

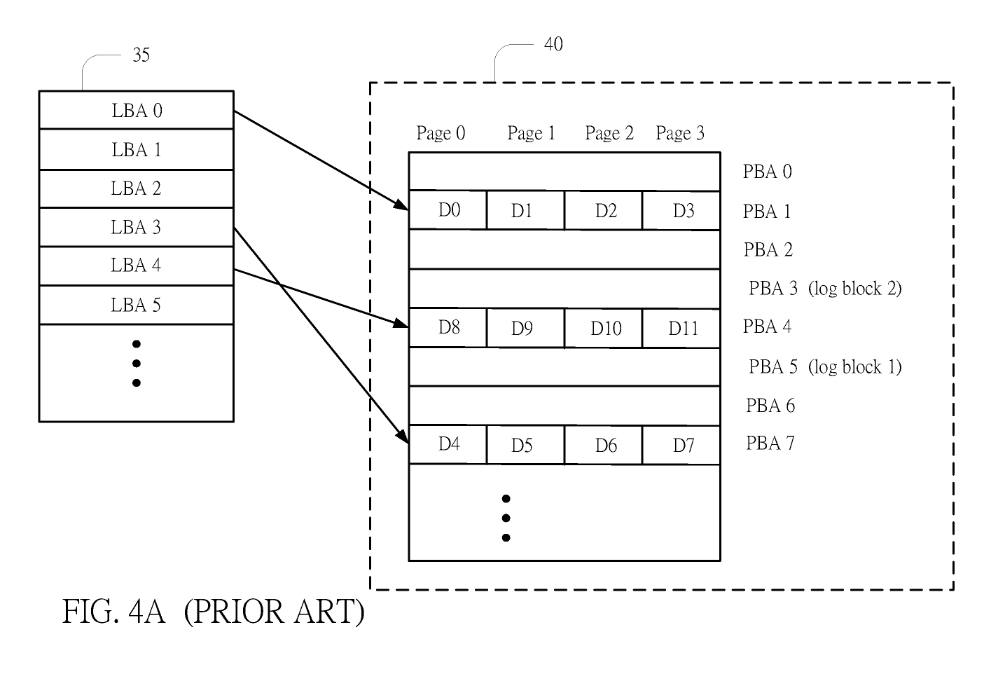

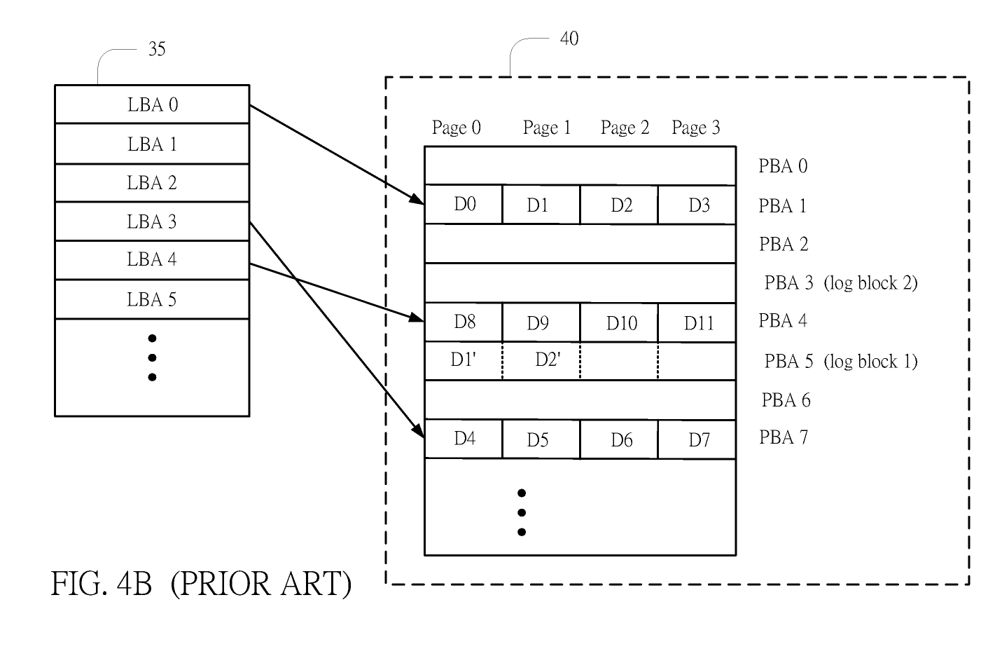

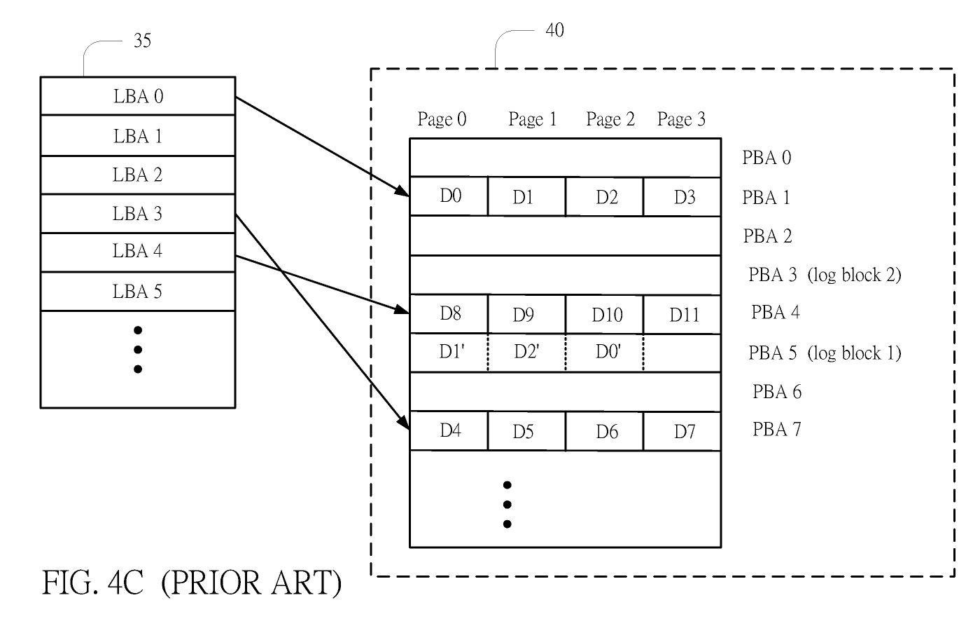

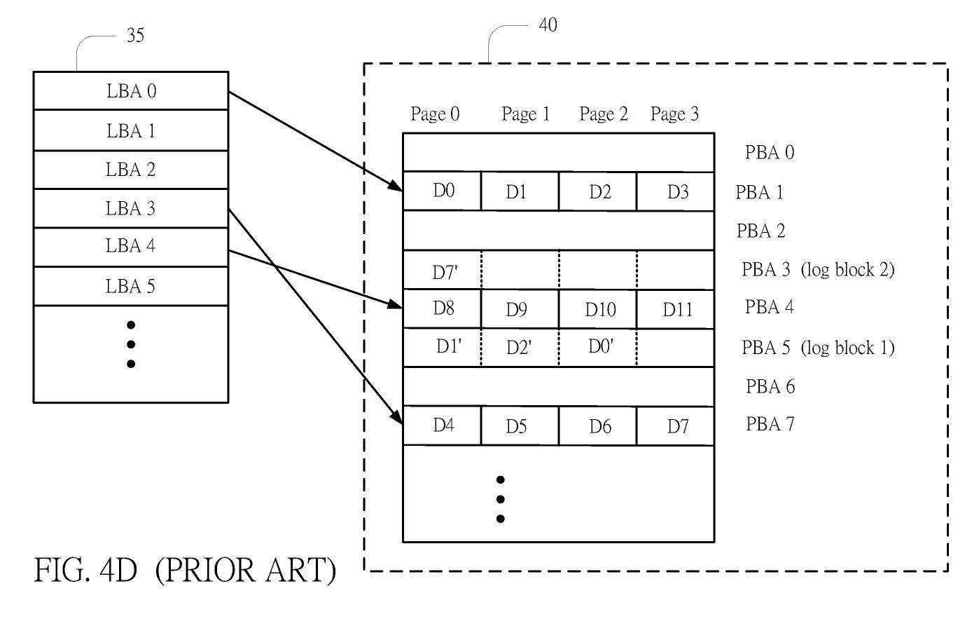

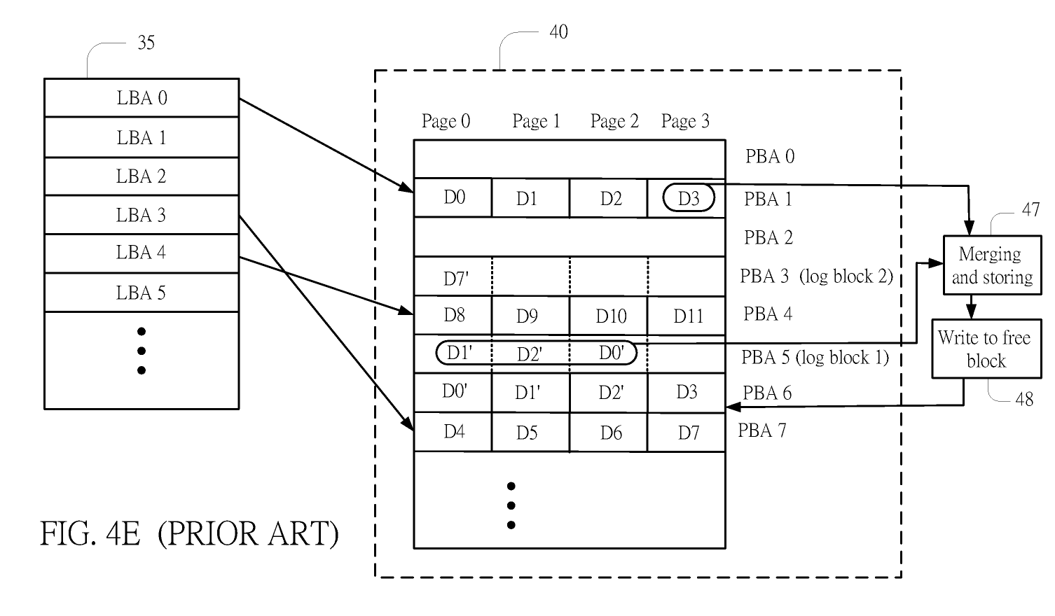

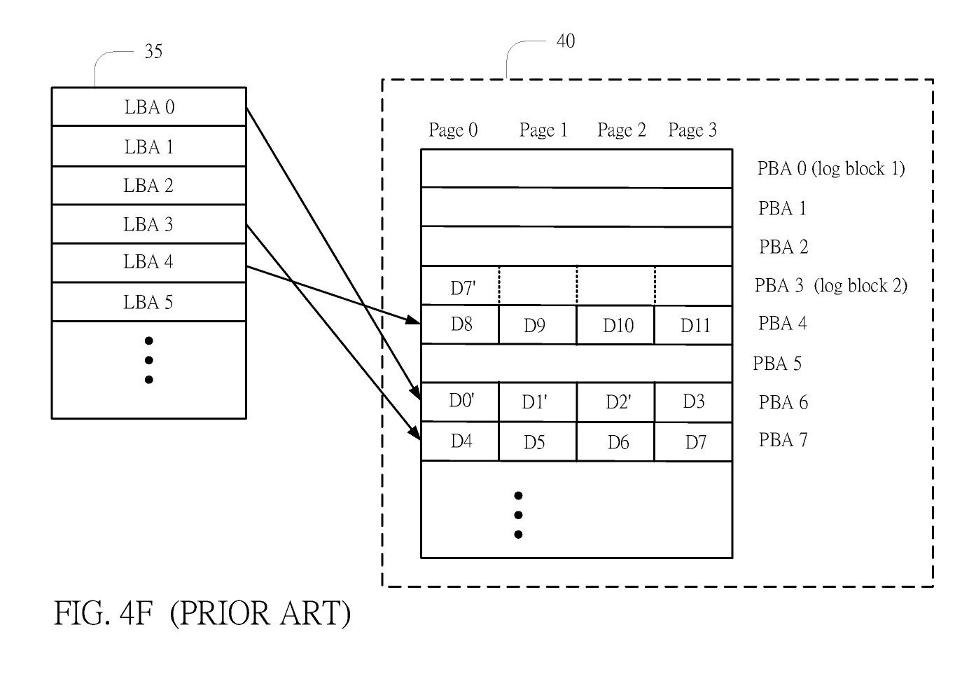

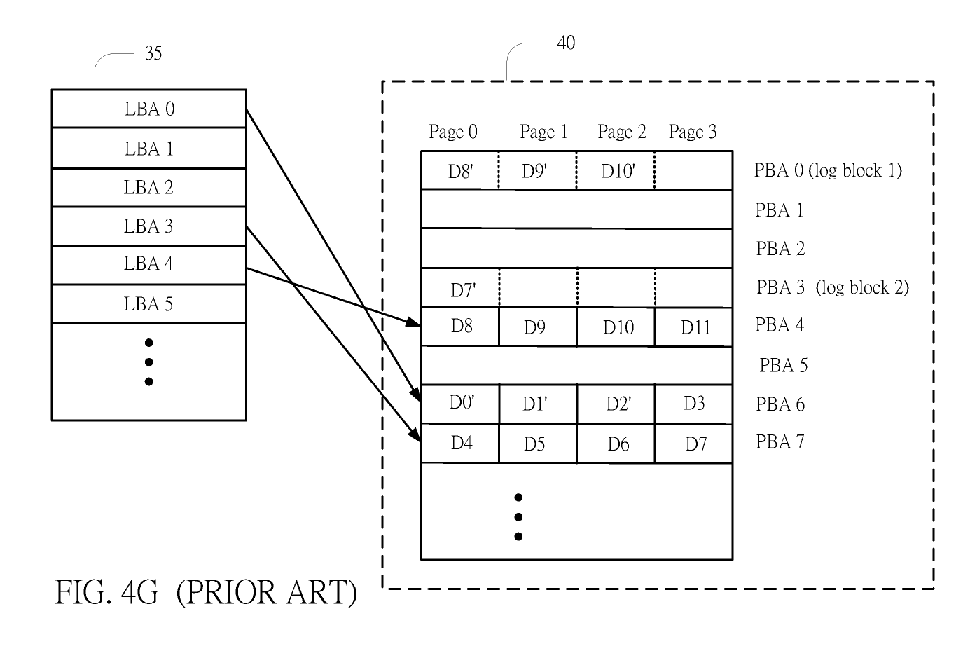

### DETAILED DESCRIPTION OF THE PREFERRED EMBODIMENT

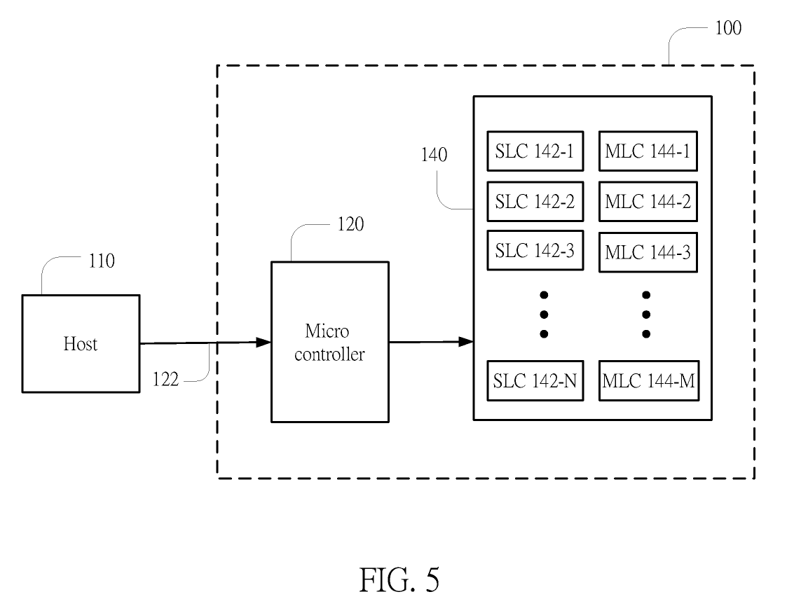

Please refer to FIG. 5, a block diagram illustrating an embodiment of a hybrid flash memory device according to the present invention. The flash memory device 100 includes a micro controller 120 and a memory module 140. In this embodiment, the memory module 140 includes both SLC flash memories 142-1˜142-N and MLC flash memories 144-1˜144-M.

Generally speaking, the host 110 accesses data in the flash memory device 100 via a host bus 122, for example, compact flash (CF) bus, secure digital (SD) bus, multimedia card (MMC) bus, universal serial bus (USB), or IEEE1394. The micro controller 120 uses a write instruction to control the memory module 140 and write data into the memory module 140 during a write operation. On the other hand, the micro controller 120 issues a read instruction to control the memory module 140 and read data to be outputted to the host 110 via the host bust 122 from the memory module 140 during a read operation.

Each of the SLC flash memories 142-1˜142-N and the MLC flash memories 144-1˜144-M is divided into a plurality of blocks, each of which includes a plurality of pages. A memory mapping table is provided in the micro controller 120. The memory mapping table contains pointers for mapping logical block address (LBA) to physical block address (PBA).

For combining the advantages of lower cost and higher storage density of MLC flash memory and shorter page programming time of SLC flash memory, the present invention utilizes both SLC flash memories and MLC flash memories to store data. Log blocks are provided in both SLC flash memories and MLC flash memories. The micro controller 120 decides whether the data are written in log block of SLC flash memories or that of MLC flash memories based on write command issued from the host 110. In this embodiment, the data are written in log block of the MLC flash memories when the data size is greater than a predetermined data size, for example one page of data. On the contrary, the data are written in log block of the SLC flash memories when the data size is not greater than the predetermined data size.

The following examples of write operation are given providing that there are four pages in each block, i.e. Page 0, Page 1, Page 2 and Page 3. The micro controller 120 defines a first log block in the SLC flash memories and a second log block in the MLC flash memories.

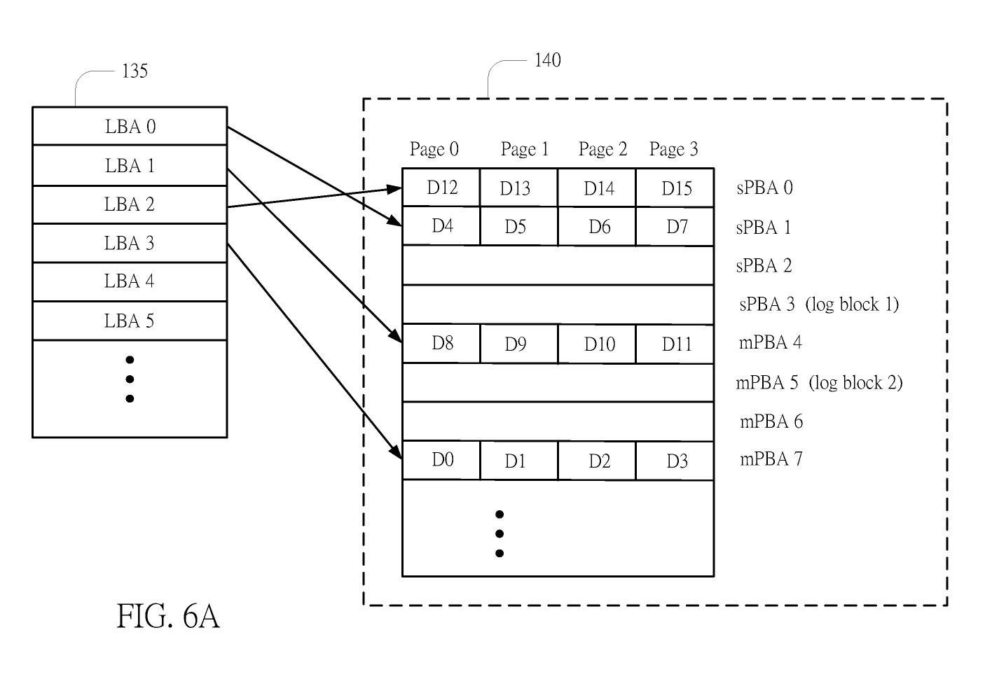

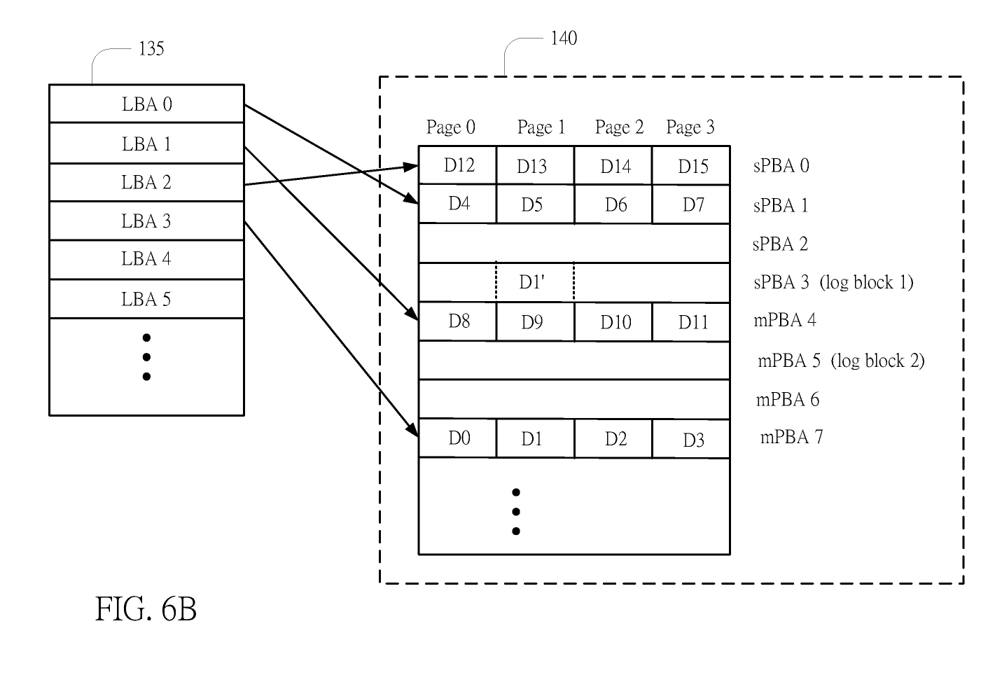

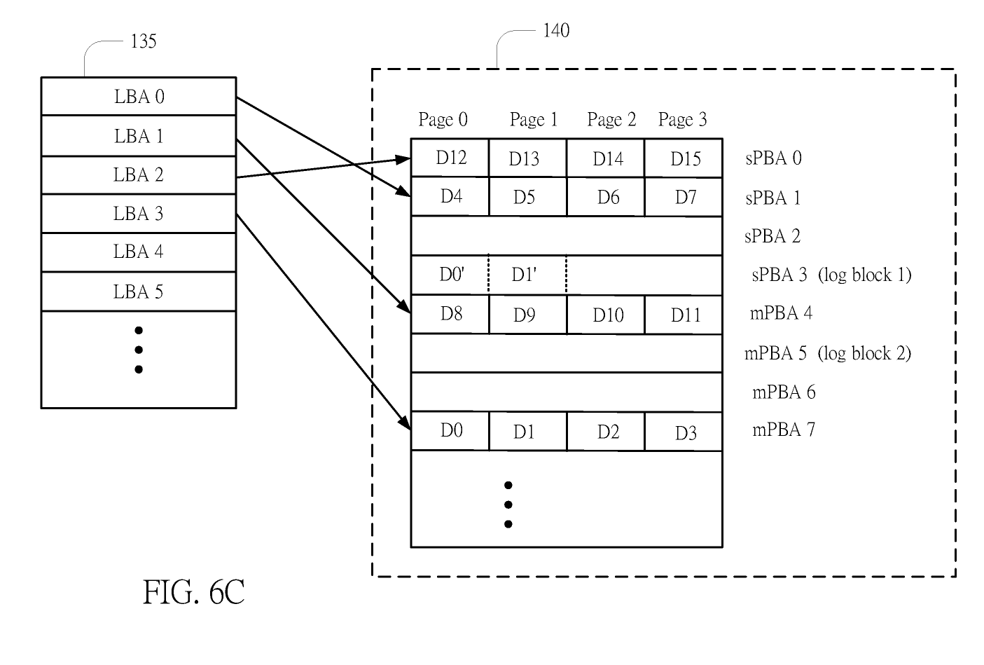

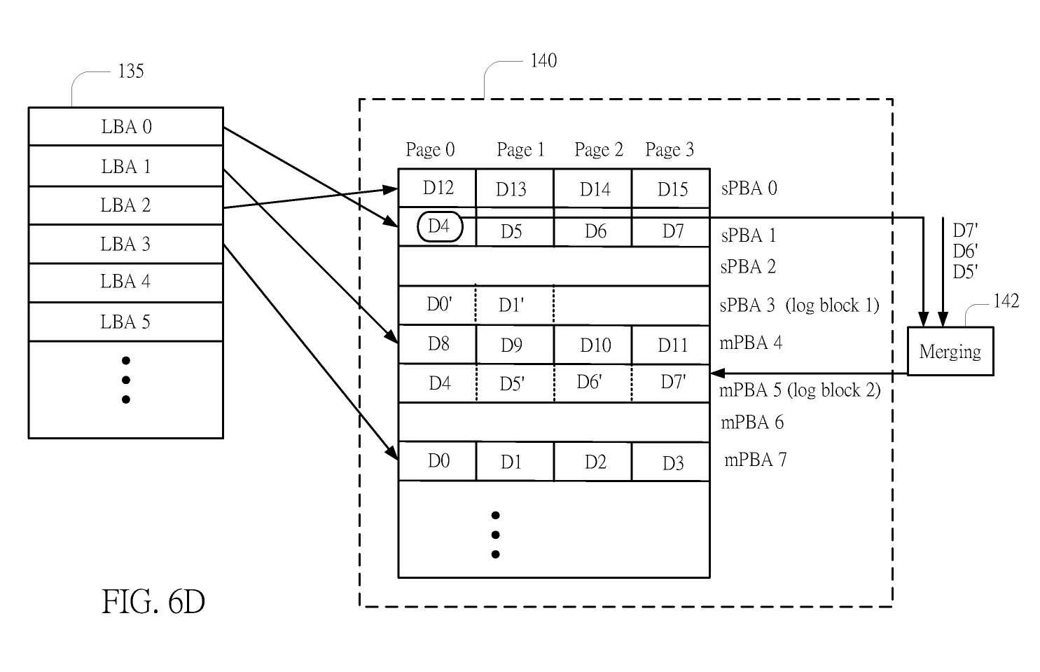

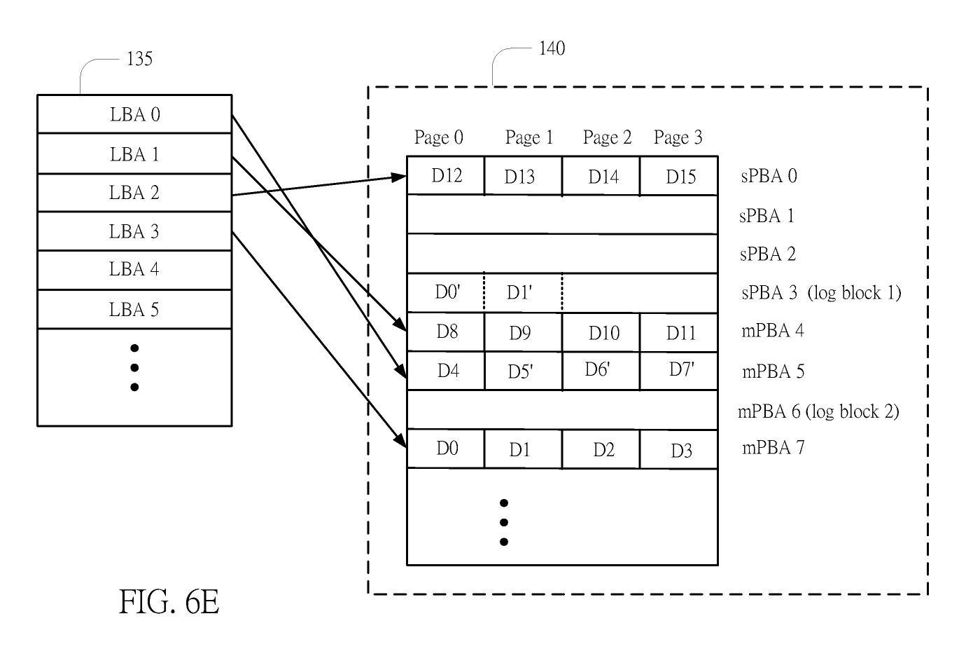

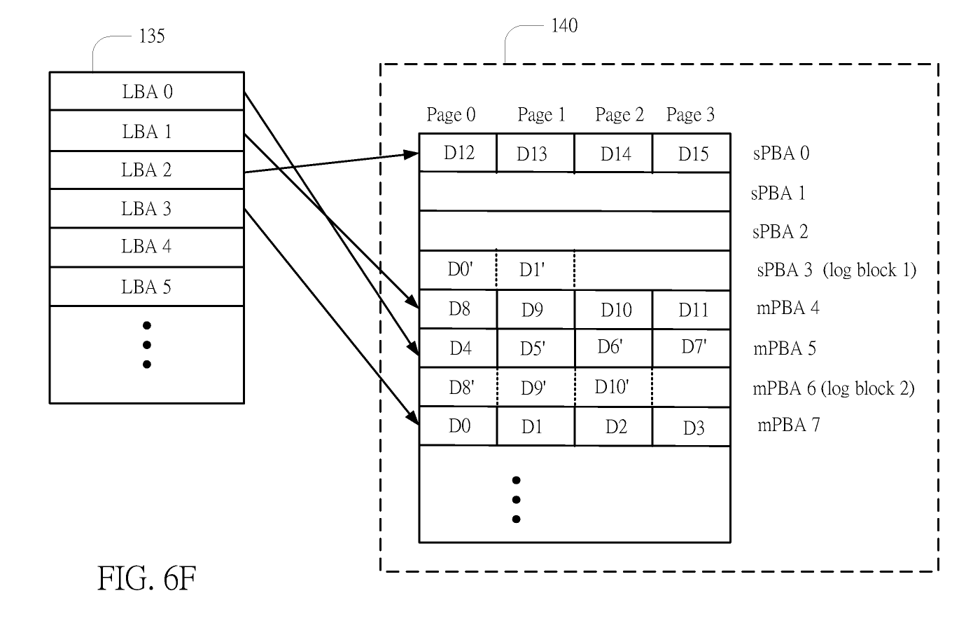

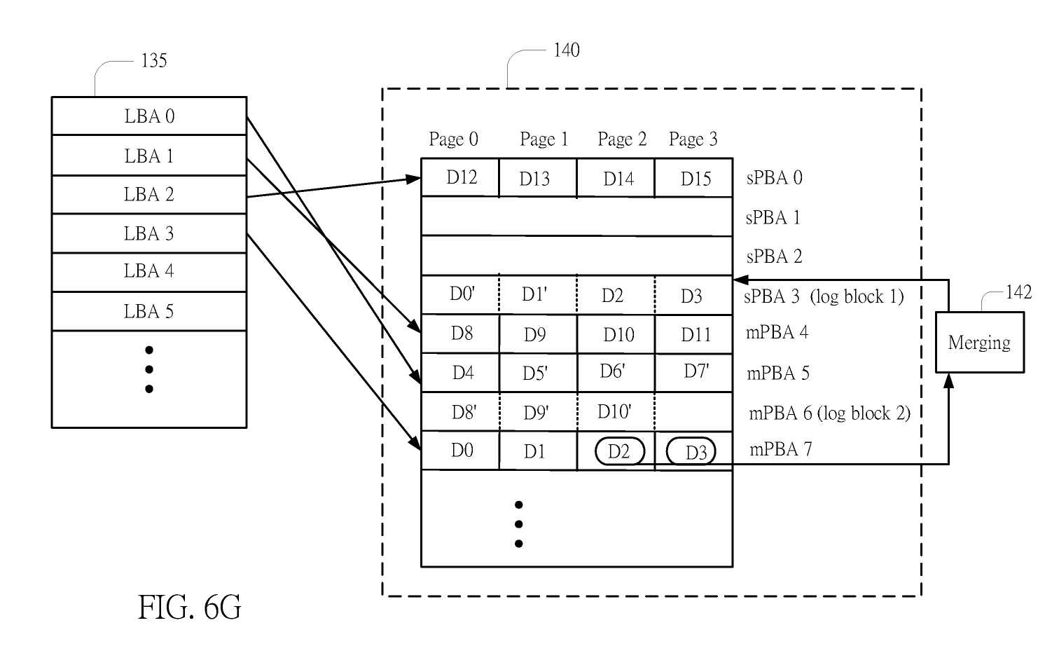

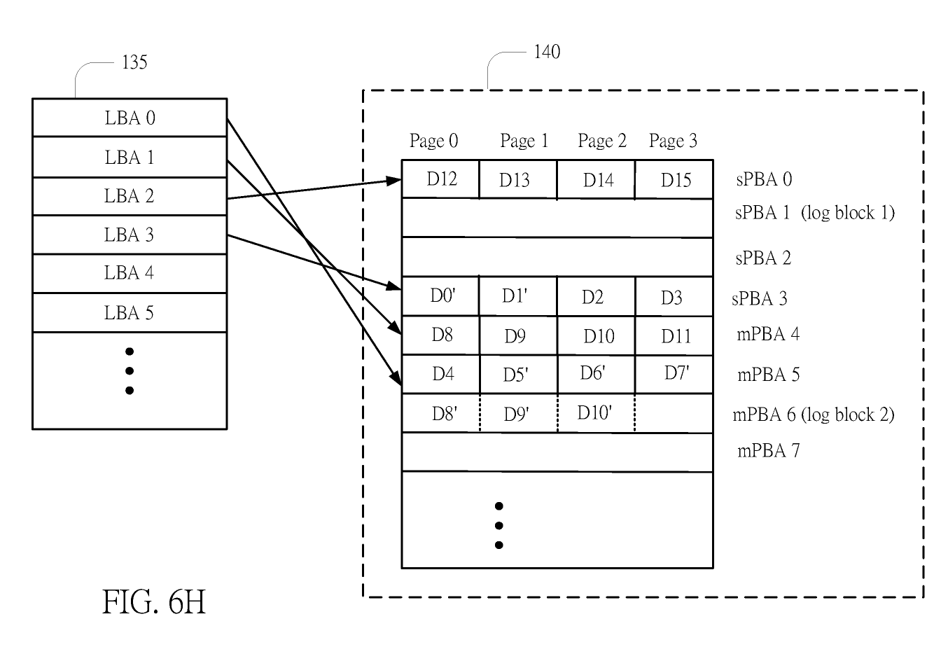

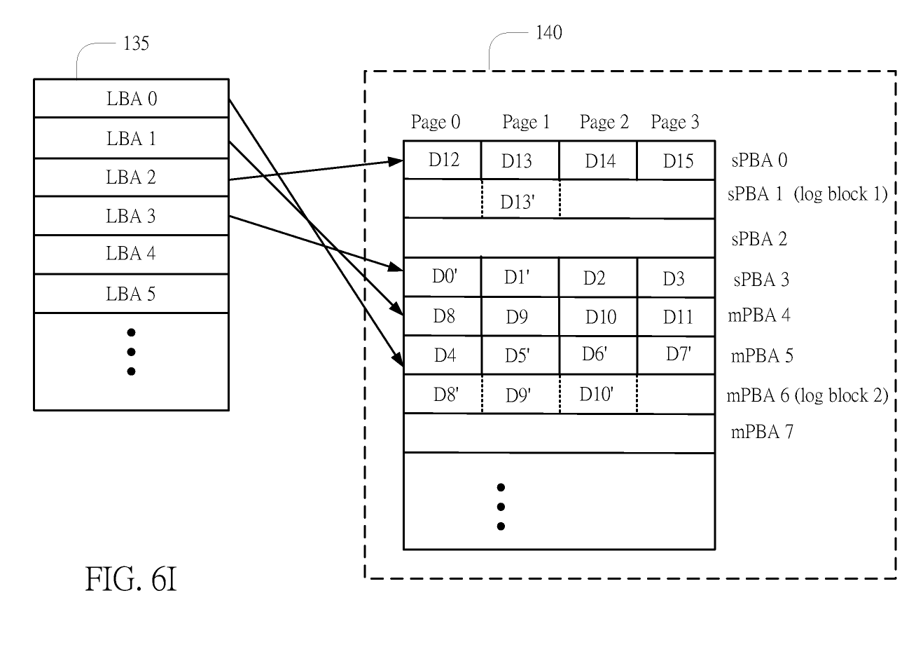

Please refer to FIGS. 6A˜6I illustrating the write operation of the hybrid flash memory device 100.

As shown in FIG. 6A, the memory module 140 at least includes SLC flash memory blocks sPBA 0˜sPBA 3 and MLC flash memory blocks mPBA 4˜mPBA 7. The memory mapping table 135 in the micro controller 20 indicates that LBA 0, LBA 1, LBA 2 and LBA 3 point to sPBA 1, mPBA 4, sPBA 0 and mPBA 7 in the memory module 140, respectively. Data D0, D1, D2 and D3 occupy Page 0, Page 1, Page 2 and Page 3 of mPBA 7; data D4, D5, D6 and D7 occupy Page 0, Page 1, Page 2 and Page 3 of sPBA 1; data D8, D9, D10 and D11 occupy Page 0, Page 1, Page 2 and Page 3 of mPBA 4; and data D12, D13, D14 and D15 occupy Page 0, Page 1, Page 2 and Page 3 of sPBA 0. Furthermore, there are two log blocks pre-set in the memory module 140 wherein sPBA 3 is allocated to the first log block and mPBA 5 is allocated to the second log block. The remained memory blocks sPBA 2 of SLC flash memory and mPBA 6 of MLC flash memory are free blocks.

In this embodiment, the write operation includes (1) the host issuing a write command to write one page of data D1′ replacing old data D1 at LBA 3 from Page 1; (2) the host issuing a write command to write one page of data D0′ replacing old data D0 at LBA 3 from Page 0; (3) the host issuing a write command to write three pages of data D5′, D6′ and D7′ replacing old data D5, D6 and D7 at LBA 0 from Page 1; (4) the host issuing a write command to write three pages of data D8′, D9′ and D10′ replacing old data D8, D9 and D10 at LBA 1 from Page 0; and (5) the host issuing a write command to write one page of data D13′ replacing old data D13 at LBA 2 from Page 1.

To start the first write step, the host issues a write command to write one page of data D1′ replacing old data D1 at LBA 3 from Page 1. As shown in FIG. 6B, the new data D1′ are directly placed in Page 1 of the first log block sPBA 3 since SLC flash memory supports writing from arbitrary page.

To start the second write step, the host issues a write command to write one page of data D0′ replacing old data D0 at LBA 3 from Page 0. As shown in FIG. 6C, the new data D0′ are directly placed in Page 0 of the first log block sPBA 3.

Then, the flash memory device receives the third write command of writing three pages of data D5′, D6′ and D7′ replacing old data D5, D6 and D7 at LBA 0 from Page 1. Since the total data size of data D5′, D6′ and D7′ is greater than a predetermined data size, the data D5′, D6′ and D7′ are placed in the second log block mPBA 5 of MLC flash memory. Please be remind again that MLC flash memory has to be written from the lowest page. At this stage, the micro controller 120 executes a merging procedure 142 to merge data D4 in Page 0 of sPBA 1 and data D5′, D6′ and D7′. Then, the merged data D4, D5′, D6′ and D7′ are placed in the second log block mPBA 5 as shown in FIG. 6D. Hence, the second log block mPBA 5 is occupied with data D4, D5′, D6′ and D7′. Then, a procedure of flushing out log block is executed for designating a free block in the MLC flash memory as a new second log block.

Then, the memory mapping table 135 id updated to have LBA 0 point to mPBA 5 as shown in FIG. 6E. The micro controller 120 selects a new second log block, e.g. mPBA 6, among the free blocks. A block erase command is issued to erase the useless data in sPBA 1, and sPBA 1 becomes available, i.e. a free block. Thus, the flushing out step is finished.

Then, the flash memory device receives the fourth write command of writing three pages of data D8′, D9′ and D10′ replacing old data D8, D9 and D10 at LBA 1 from Page 0. Since the total data size of data D8′, D9′ and D10′ is greater than the predetermined data size, the data D8′, D9′ and D10′ are placed in the second log block mPBA 6 of the MLC flash memory as shown in FIG. 6F. The micro controller 120 directly write the data in Page 0, Page 1 and Page 2 in the second log block mPBA 6 without the merging procedure 142 because the data D8′, D9′ and D10′ are written from the lowest page, i.e. Page 0.

The last write command of writing one page of data D13′ replacing old data D13 at LBA 2 from Page 1 follows. Since the total data size of data D13′ is not greater than the predetermined data size, the data D13′ should be placed in the first log block sPBA 3 of the SLC flash memory. The first log block sPBA 3, however, is partially occupied. Hence, the micro controller 120 has to define a new first log block from the free blocks.

As shown in FIG. 6G, a merging procedure 142 is used to merge the data D0′ and D1′ with the data D2 and D3 in Page 2 and Page 3 of mPBA 7. Now the first log block sPBA 3 is occupied with data D0′, D1′, D2 and D3.

Then, the memory mapping table 135 is updated to have LBA 3 point to sPBA 3 as shown in FIG. 6H. The micro controller 120 selects a new first log block, e.g. sPBA 1, among the free blocks. A block erase command is issued to erase the useless data in mPBA 7, and mPBA 7 becomes available. Once sPBA 1 is allocated to the new first log block, the data D13′ can be placed in Page 1 of the new first log block as shown in FIG. 6I.

From the above description, the data are determined to be written in a MLC flash memory when their data size is greater than a predetermined data size. The micro controller 120 will merge the written data with other data stored in the previous page(s) including the initial page, i.e. Page 0. The conventional storing procedure and write to free block procedure required for MLC flash memory are omitted during flushing out log block so as to simplify the write operation and thus significantly increase the efficiency of the memory module 140.

The present invention does not limit to a hybrid flash memory device only consisting of SLC flash memories and MLC flash memories. Typically, flash memories are classified into first grade or second grade after production. Flash memories classified into first grade means better quality, longer lifetime, higher reliability and lower data error rate than those classified into second grade. According to the principle of the present invention, the data are determined to be written in a first grade flash memory when their data size are not greater than a predetermined data size. On the contrary, the data are determined to be written in a second grade flash memory when their data size are greater than the predetermined data size. The predetermined data size can be determined based on the demands or operation conditions. This arrangement can decrease the total writing times of the second grade flash memories to prolong their lifetime. Furthermore, the reduced production cost is achieved because the cheaper second grade flash memories can substitute portions of the high-priced first grade flash memories in the memory module without affecting the performance of the hybrid flash memory device.

While the invention has been described in terms of what is presently considered to be the most practical and preferred embodiments, it is to be understood that the invention needs not to be limited to the above embodiments. On the contrary, it is intended to cover various modifications and similar arrangements included within the spirit and scope of the appended claims which are to be accorded with the broadest interpretation so as to encompass all such modifications and similar structures.

What is claimed is:

1. A hybrid flash memory device comprising:
a micro controller connected to a host bus for receiving data to be written in the hybrid flash memory device from a host via the host bus; and
a memory module coupled to the micro controller and comprising therein a first type of flash memory and a second type of flash memory,
wherein the data are written in a first log block of the first type of flash memory when the data have a size not greater than a predetermined data size, and the data are written in a second log block of the second type of flash memory when the data have a size greater than the predetermined data size.

2. The hybrid flash memory device according to claim 1 wherein the data to be written in the second log block are written in pages including an initial page of the second log block.

3. The hybrid flash memory device according to claim 1 wherein the data to be written in the second log block are merged with previous data stored in at least one page including an initial page, and the merged data are written in the second log block.

4. The hybrid flash memory device according to claim 1 wherein the first type of flash memory is a single level cell NAND flash memory and the second type of flash memory is a multi level cell NAND flash memory.

5. The hybrid flash memory device according to claim 1 wherein the first type of flash memory is a first grade flash memory and the second type of flash memory is a second grade flash memory.

6. The hybrid flash memory device according to claim 1 wherein the hybrid flash memory device is produced as one of a thumb drive, a compact flash device, a secure digital device and a multimedia card device.

7. A method of controlling a hybrid flash memory device comprising a first type of flash memory and a second type of flash memory, the method comprising steps of:
receiving data to be written in the hybrid flash memory device from a host;
writing the data in a first log block of the first type of flash memory when the data have a size not greater than a predetermined data size; and
writing the data in a second log block of the second type of flash memory when the data have a size greater than the predetermined data size.

8. The method according to claim 7 wherein the data to be written in the second log block are written in pages including an initial page of the second log block.

9. The method according to claim 7 wherein the data to be written in the second log block are merged with previous data stored in at least one page including an initial page, and the merged data are written the second log block.

10. The method according to claim 7 wherein the first type of flash memory is a single level cell NAND flash memory and the second type of flash memory is a multi level cell NAND flash memory.

11. The method according to claim 7 wherein the first type of flash memory is a first grade flash memory and the second type of flash memory is a second grade flash memory.

12. The method according to claim 7 wherein the hybrid flash memory device is produced as one of a thumb drive, a compact flash device, a secure digital device and a multimedia card device.
